(19) United States
(12) Patent Application Publication
(10) Pub. No.: US 2007/0203931 A1
(43) Pub. Date: Aug. 30, 2007

(54) Creating and Managing XML Schema Version Transformations

(76) Inventors: Jacob Paul Ukelson, Tel-Aviv (IL); Tse'elon Ben-Barak, Tel-Aviv (IL)

Correspondence Address: FENWICK & WEST LLP, SILICON VALLEY CENTER, 801 CALIFORNIA STREET, MOUNTAIN VIEW, CA, 94041, US

(21) Appl. No.: 11/671,993

(22) Filed: Feb. 6, 2007

Related U.S. Application Data
(60) Provisional application No. 60/765,543, filed on Feb. 6, 2006.

(51) Int. Cl. G06F 7/00

(52) U.S. Cl. 707/101

(57) ABSTRACT

Systems and methods create customized executables for translating a message received in a source XML schema version to a target XML schema version. After identification of the source and a target versions, a customizable mapping specification allows designation of an automatic and/or manual mapping. The mapping is processed using mapping default standards-organization provided, or manually-created routines. Mapping execution results are displayed to allow for error identification and manual re-mapping of elements if necessary. An executable is rendered capable of translating messages from the source XML schema version to the target XML schema version.

### RELATED APPLICATIONS

This application claims the benefit under 35 U.S.C. § 119(e) of Provisional Patent Application Ser. No. 60/765,543, entitled “Method for Creating and Managing Transformations XSD Schema Versions,” filed Feb. 6, 2006, and is related to patent application Ser. No. 11/177,329, entitled “System and Method for Data Format Transformation,” filed Jul. 11, 2005, which claims priority from Application Ser. No. 60/586694, filed Jul. 12, 2004, and is related to application Ser. No. 11/238,583, entitled “Information Converter and a Method for Transforming Information,” filed Sep. 29, 2005, which claims priority from No. 60/702,889 filed Jul. 26, 2005, each of which are incorporated by reference herein in their entirety for all purposes.

### BACKGROUND

The present invention relates generally to extensible markup language (XML) schema versioning, and more specifically to translating of messages from one XML schema version to another XML schema version.

Many current messaging standards are defined and released in the form of XML files (e.g., ACORD, HL7, SWIFTML, ISO 20022), which have schema descriptions associated with them in the form of XSDs (XML schema definitions), or other specifications that can be transformed into XSD by various mechanisms. These standards and schemas evolve over time and are updated by standards setting organizations. As these updates are published, users must either change their messaging systems accommodate the revisions or decide to not embrace the revisions (remaining compliant only with older versions).

In business-to-business systems, users interact with other users, who may use systems compliant with any of the current or previous versions of the standard. If different business systems are compliant with different versions of a standard, then communication between them may be hindered or impossible. Compounding the issue is the fact many business modify their implementation of a standard in order to meet specific business needs. Thus, when a new version is announced, not only do systems need to be modified to accommodate the new version, the modification made for business purposes must also propagated to the new version.

As more and more messaging standards move towards XML, these problems of incompatibility between implementations, and the costs and inefficiencies of version maintenance will be become more widespread.

There are a few (not many) existing methods and systems for schema versioning for document type definitions (DTD)-to-DTD matching, or database table-to-table matching. None are known for the more complex XSD-to-XSD versioning described herein. There also are also some academic papers that focus on schema matching, but not on schema versioning as described herein (and the process and tools therefore), e.g., usable for large messaging schemas (e.g., ACORD).

### SUMMARY

The present invention provides methods and systems for schema versioning for XSD-to-XSD transformations usable, in particular for versioning of large messaging schemas. These allow users to easily standardize on a specific version of a schema, while enabling use of other versions of the same schema.

The method and system allows for creation of a customized executable for translating a message received in a source extensible markup language (XML) schema version to a target XML schema version. After a source XML schema version and a target XML schema version are identified, a customizable mapping specification is loaded using the selected versions, which provides formats the versions into the specification format. This mapping is displayed, and the user is enabled to designate for each schema element, whether to use automatic mapping routines and/or to specify individual elements in the source and target schemas for manual mapping. The user edited mapping is processed using a set of mapping routines that may include default routines, routines provided by a standards organization, and/or manually-created routines. Mapping execution results are displayed for the executed mapping to allow for manual mapping of elements if necessary. The user can modify the mapping again, if desired. Once the user approves the mapping, an executable file is generated, that is configured to translate a message from the source XML schema version to a message in the target XML schema version, and may be in a user-specific output format.

The description in the specification is not all inclusive and, in particular, many additional features will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a flowchart illustrating a method of creating a customized executable for translating a message from one XML schema version into another XML schema version according to one embodiment of the present invention.

FIG. 2A-2B depict a user interface showing one embodiment of a customizable mapping specification.

FIG. 2C depicts a user interface showing a mapping result display and customizable mapping specification.

FIG. 2D depicts a user interface showing a transformation column for invoking a substring transformation or expression.

FIG. 2E depicts a user interface showing a expression builder sheet.

FIG. 3 is a portion of a computer-readable script corresponding to FIG. 2A.

FIG. 4 is a portion of a computer-readable script corresponding to FIG. 2C.

FIG. 5 is a block diagram illustrating the architecture of one embodiment of a system useful for supporting the method of FIG. 1.

FIG. 6 shows a portion of an XML schema description (XSD) for ACORD v. 1.2.0.

FIG. 7 shows a portion of an XSD for ACORD v. 1.3.1.

FIG. 8 shows a request pertaining to the portion of the XSDs shown in FIGS. 6 and 7.

FIG. 9 shows a response pertaining to the portion of the XSDs shown in FIGS. 6 and 7.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

The methods and systems described herein allow for automatic generation of mappings between two schema versions. Automatic translation is provided for similar elements between the two schema versions, and a mechanism is included to notify the user when automated translation is not possible. In addition, a user can define mappings for elements for those not automatically generated. The methods and system allow a user to override and change automatic mappings of schema nodes, and provide for management of changes to previously generated mappings.

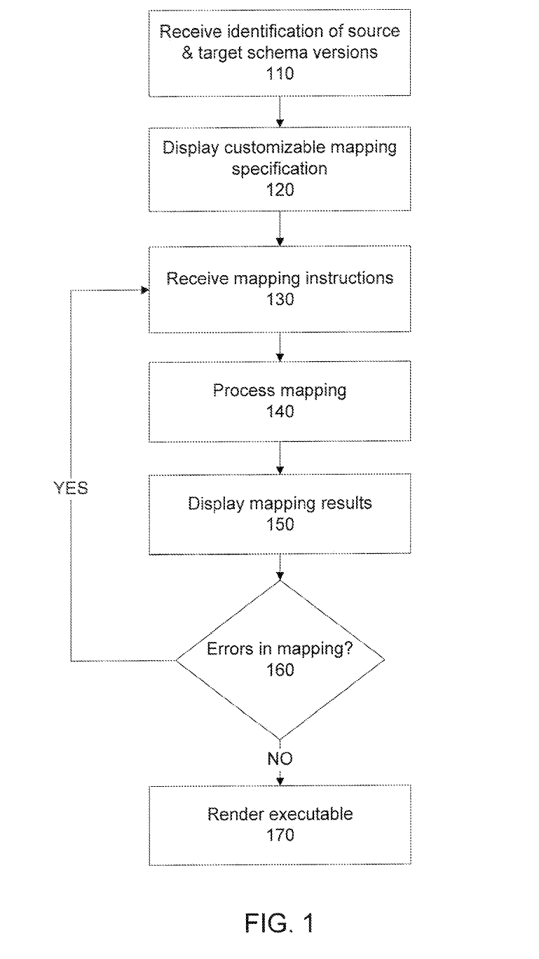

Referring now to FIG. 1 is a flowchart illustrating a method of creating a customized executable for translating a message from one XML schema version into another XML schema version according to one embodiment of the present invention.

The method begins with receiving 110 identification of a source XML schema version and a target XML schema version. The source XML schema version and the target XML schema version may be selected from an available list of stored schema versions.

The schema versions between which the transformations take place can have various degrees of similarity. For example, commonly schemes such as XML v. 1.1.1 and XML v. 1.1.2 (minor updates to a version) are very similar, whereas XML v. 1.1.1 and XML v. 2.1.1 (a truly new “version”) have more differences, although numbering conventions are not always used consistently. The method and system described herein are useful for various degrees of similarity, however, the extent to which the automated portions of the mapping proceed are often less in versions with less similar structures.

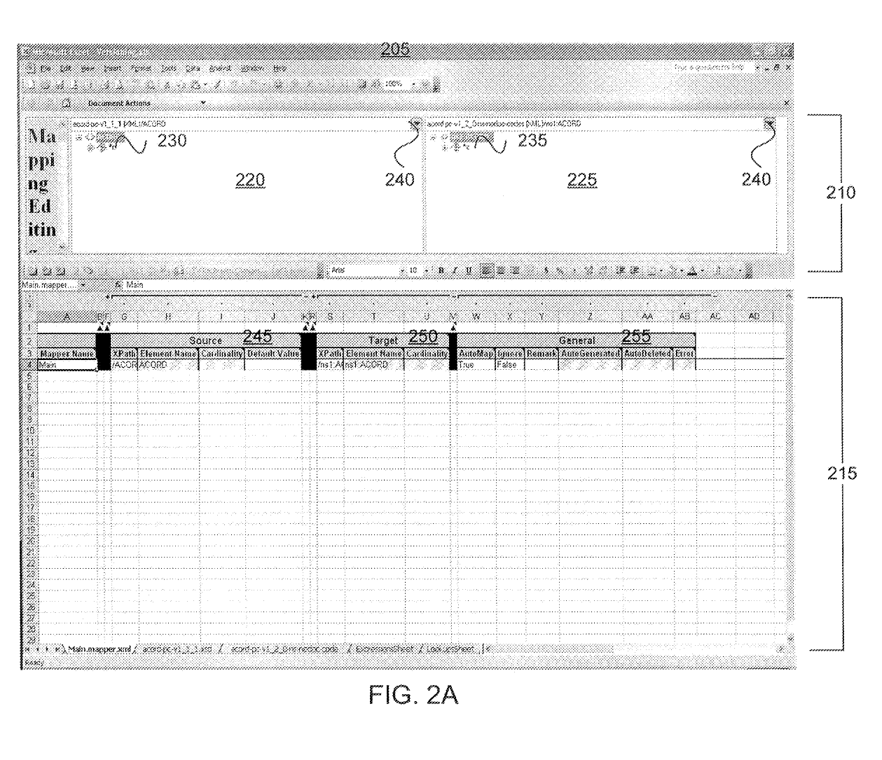

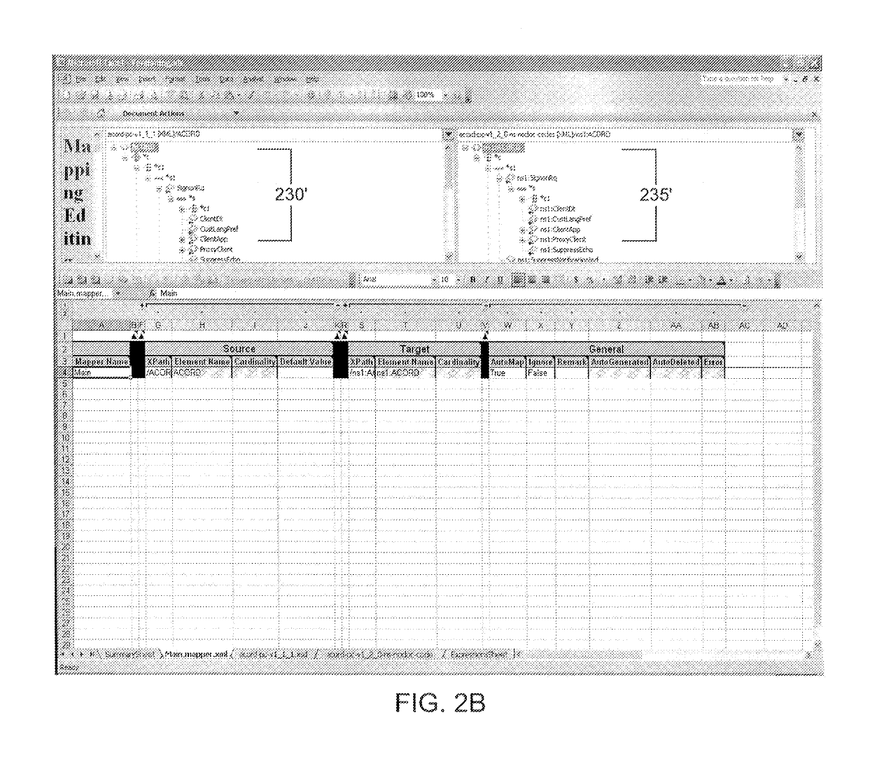

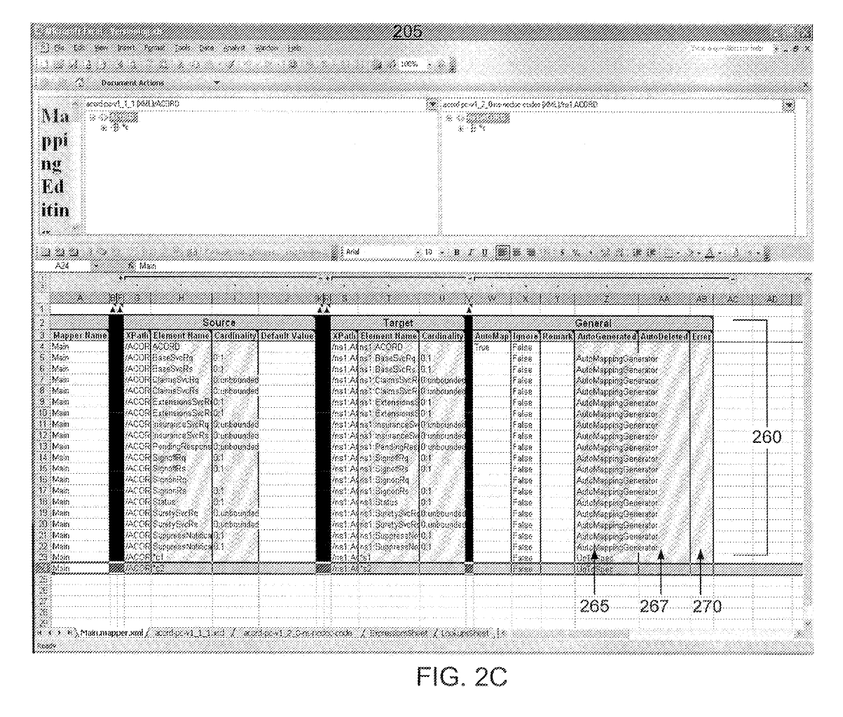

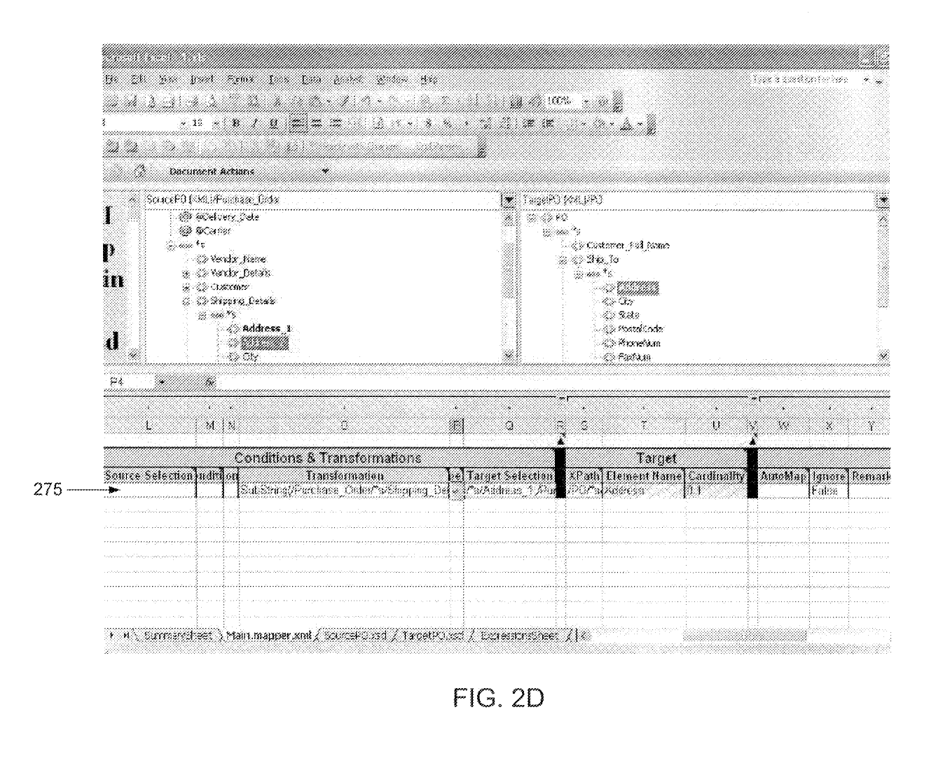

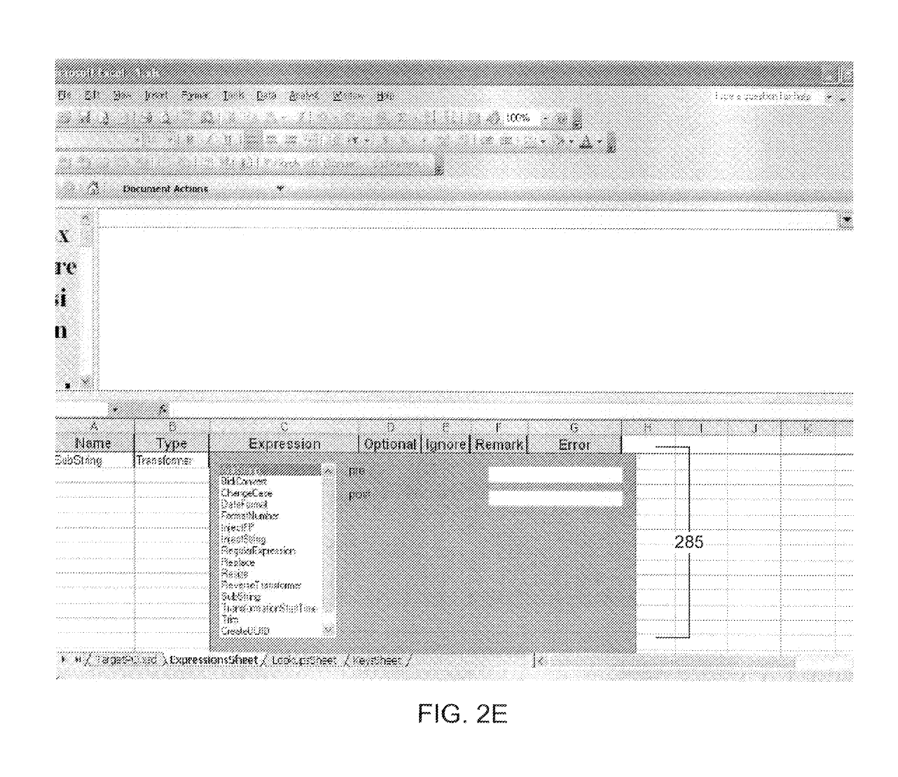

The source and target version identifications 110 may be selection via a user interface as described further in conjunction with FIGS. 2A-2D.

In addition, information may be received regarding a desired messaging format for the executable.

Following identification 110, a customizable mapping specification is prepared and loaded into the specification format from the source and target versions and displayed 120 for a mapping the source XML schema version to the target XML schema version. The customizable mapping specification provides the ability for the user to specify automatic and manual functionality for the mapping.

The customizable specification maybe presented in the form of a user interface display and/or spreadsheet, as described in greater detail in conjunction with FIGS. 2A-2E.

Next, a set of instructions for the mapping are received 130 from the user via the user interface, the instructions designating elements of the mapping for automatic and manual mapping. The instructions may indicate a completely automatic mapping, a mix of automatic and manual mappings, or a completely manual mapping. This allows the user the greatest ability to customize the mapping for the business use of messages that will be subjected to the mapping transformation, and allows for iterative construction of the version mapping.

The user can select manual or automatic mapping on an element by element basis, and/or can choose to include one or more instructions not to map selected elements.

The mapping is then processed 140 according to the specification and instructions. The mapping comprises application of a set of mapping routines as further described below.

The mapping routines may include known schema matching techniques and algorithms, for example as provided by a standards-setting organization, or such as described in Bernstein et al., Industrial Strength Schema Matching, SIGMOD Record, 33(4), 38-43 (Dec. 2004) and Rahm et al., Matching Large XML Schemas, SIGMOD Record, 33(4), 26-31 (Dec. 2004), each of which are incorporated herein by reference, and/or manually created mappings may be used. In addition, a set of default routines chosen from these techniques may be run if automatic mapping is selected. The default routines may be include similarity, schema structure, thesauri, instances, value distribution of instances, constraints, past mappings, similarity to standard schemas, and cluster analysis of a schema corpus.

If the user chooses to include one or more instructions not to map selected elements, the processing 140 is omitted for the selected elements. If the user includes a manual mapping for one or more selected elements, the processing substitutes the manual mapping for an automatic or default/standard mapping. Thus, the system allows for easier communication between business systems using different versions of a standard, and allows for customized modifications for a business' implementation of a standard in order to meet specific business needs.

The execution results of the mapping are then displayed 150. An example of execution results is discussed in further detail in conjunction with FIG. 2C. From the result display, a determination 160 can be made whether any errors occurred in the mapping or of any elements or sub-elements were not mapped.

The results may include an indication that specified elements were not mapped, for example in the form of an error message or a mapped element report. However, an error or failure of an element in the mapping does not cause failure of the entire mapping.

In response to any errors in mapping, the user may provide (130) via the customizable specification additional instructions for the mapping corresponding to elements with errors, and re-process (140) the mapping according to the additional instructions.

Once the user is satisfied with the mapping specification, an executable file is rendered 170 from the mapping. The executable is configured to translate messages from the source XML schema version to a message in the target XML schema version according to the mapping. The executable may be in the form of a computer-readable script, such as a CM script or a Java program, etc. If an updated mapping exists as a result of adding manual mappings for elements that previously produced errors, the updated mapping is reflected in the executable. In addition, the executable may be further formatted into a desired data messing format, as per the specification received in conjunction with step 110.

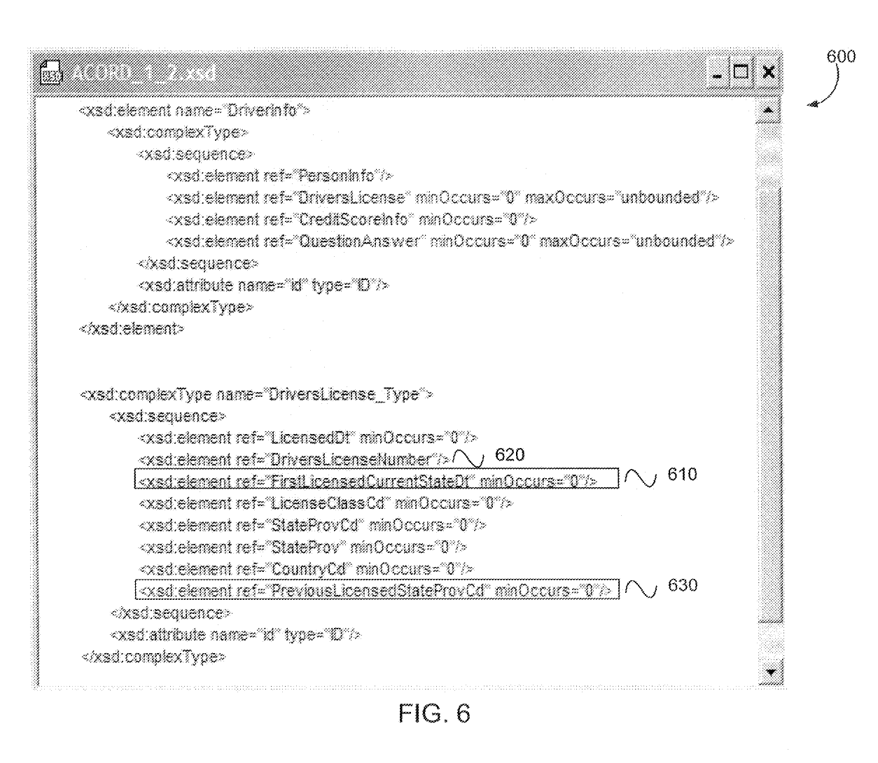

The executable then can be used to transform all messages in one version to the other, for example incoming and outgoing messages, as described in conjunction with FIGS. 6-9. This allows for easy definition of a implementation-specific data dictionary, which allows the user to see how internal business terms map to the language of the customizable specification and industry standards.

Additional functionality also may be used, for example, to transform incoming messages in a specific format into an XSD compatible with the methods described herein. See, e.g., application Ser. Nos. 11/177,329 and 11/238,583, which are incorporated by reference herein.

Examples of schema version transformation and corresponding message alterations are discussed in conjunction with FIGS. 6-9.

FIG. 2A is a user interface showing one embodiment of a customizable mapping specification 205 as described above. The specification 205 includes a display area 210 and a spreadsheet area 215.

The display area 210 includes a source tree section 220 and a target tree section 225 that allow for import, display, and/or manipulation of a source tree 230 and a target tree 235, respectively. Source and target trees 230, 235 can be selected and imported in various ways, including via drop down menus 240. The drop down menus may be populated with known schema versions, e.g., from a set of stored schemas. The source and target trees 230, 235 may be expanded, e.g., as shown in FIG. 2B. Using the expanded trees 230′, 235′, the display area 210 allows for drag and drop functionality, e.g., of tree elements, between the source and target sections 220, 225.

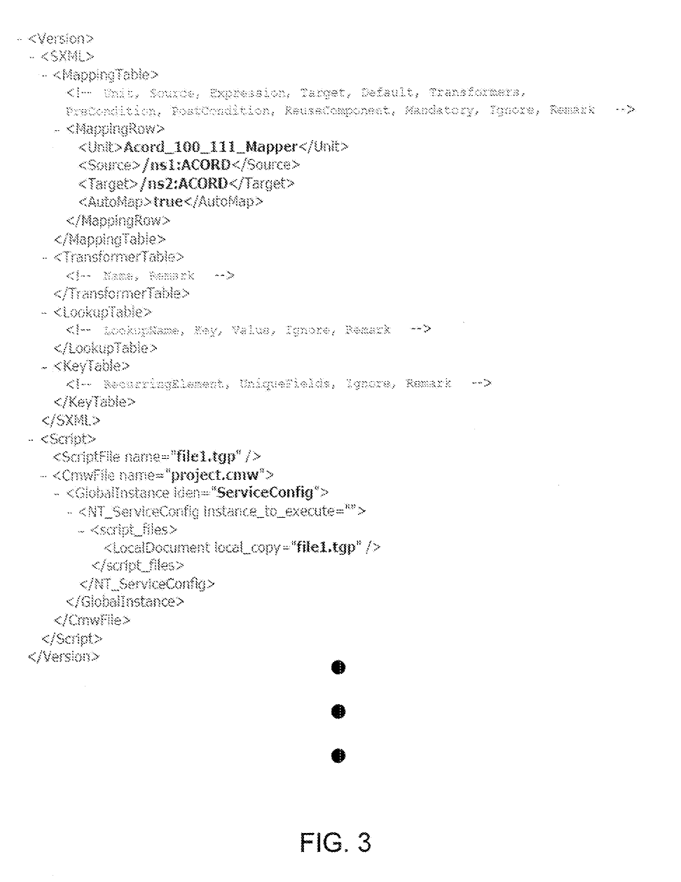

The spreadsheet area 215 corresponds to the information displayed in the display area 210. The spreadsheet area 215 has rows and columns corresponding to source information 245, target information 250, and general information 255. For each element and/or sub-element of the source, there is provided a row, in which columns correspond to an xpath, a name, and cardinality, as well as a default value for the source information. The general information may include a column indicating whether to run automatic mapping for each element or sub-element. The example shown displays only the root element and an indication to run automatic mapping. From this information, the user may process the mapping, e.g., using a button or the like for this purpose. An automatic mapping using only the root element indicates to the system to run an automatic mapping to that element and all of its subelements, i.e., the entire tree in this example. Alternatively, the user can specify specific elements not to automatically map and/or can manually specify a mapping for specific elements, if desired, e.g., as described further in conjunction with FIG. 2C. A portion of a computer readable script corresponding to the mapping specification shown in FIG. 2A is shown in FIG. 3. This is the script as it looks before the automatic mapping is run; the ellipse indicates that it is not the entire file.

FIG. 2C is a user interface showing a mapping result display 260 and customizable mapping specification 205 as described above. The user interface of FIG. 2C differs from that of FIG. 2A in that the mapping has been run, as indicated by entries in the AutoGenerated and AutoDeleted columns 265, 267. These columns 265, 267 are generated by the versioning engine of the system. The rows of FIG. 2C list the elements and sub-elements that have been mapped.

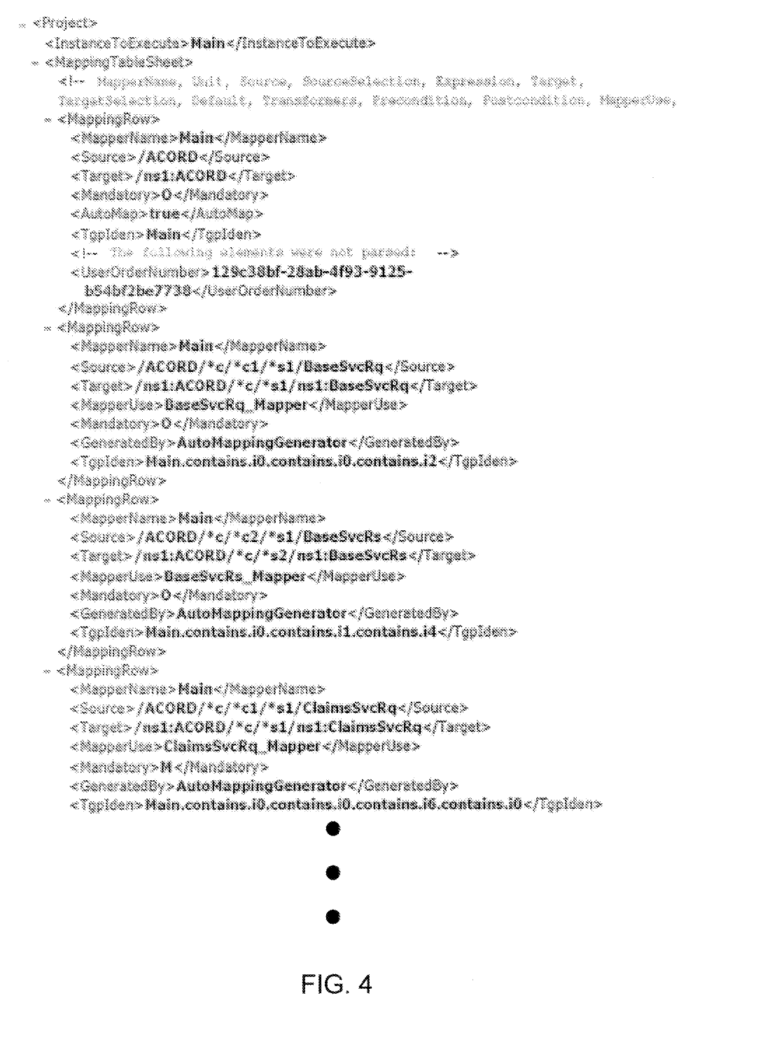

The interface of FIG. 2C also may be used as a customizable mapping specification 205 as described above. For example, if a user wants to select, element by element (or sub-element), whether to automatically map each element, or wants to provide a custom mapping for one or more elements or sub-elements, a list of individual elements such as shown here can facilitate the process. For any element for which the user specifies a manual mapping, the manual mapping will override any default or standard automatic mapping for that element. Thus allows the user greater flexibility and control over the mapping process, and allows for greater customization and easy translation, e.g., of non-standard fields used for business purposes. A portion of a computer readable script corresponding to the mapping specification shown in FIG. 2C is shown in FIG. 4.

The user may specify a variety of types of manual mappings. For example, the user may specify to add or remove elements, to copy elements, or to alter the content of elements. For example, if there are fields that are not used for the user's business purposes, the user can select to remove from the mapping the elements corresponding to those fields. In another example, for business reasons, the user may use a version (e.g., v. 1.4) in a non-standard way, e.g., information for which an element does not exist may be hidden in another field (e.g., CustomerName). Then, if a version comes out that does include a field for the hidden information, the user can create a manual mapping that parses the Customer Name field to remove the extraneous information.

FIG. 2D shows a third example. Using the spreadsheet area 215 and specifying the xpath for the source with the extra information, e.g., the source xpath in row 275 in the spreadsheet area 215 of FIG. 2D, and using a transformation column 280 to invoke a substring transformation or expression (in this example, a concatenation of two field values to be placed in a single target field), the user can specify a manual mapping. This is the script as it looks after the automatic mapping is run; the ellipse indicates that it is not the entire file.

FIG. 2E is a user interface showing a expression builder sheet 285 that allows for tailoring of built-in expressions, or building of a custom expression, e.g., using JavaScript, the Excel expression language, or another expression language.

If after the mapping is run, any of the elements has not been mapped, an entry would be shown in the Error column 270. Alternatively, the user could be presented with a report indicating which elements were not mapped. In addition, once a mapping is run, if any elements do not properly map and/or yield an error, the user can create a custom/manual mapping for that element, as described above, and re-run the mapping. Generation of an error for an element does not fail the entire transformation or affect other elements. Thus, the user unfamiliar with the differences between the schema versions can begin by running the automatic mapping first for all elements, and from the result see in for which elements, if any, errors are presented, and then manually map those elements and re-run the mapping.

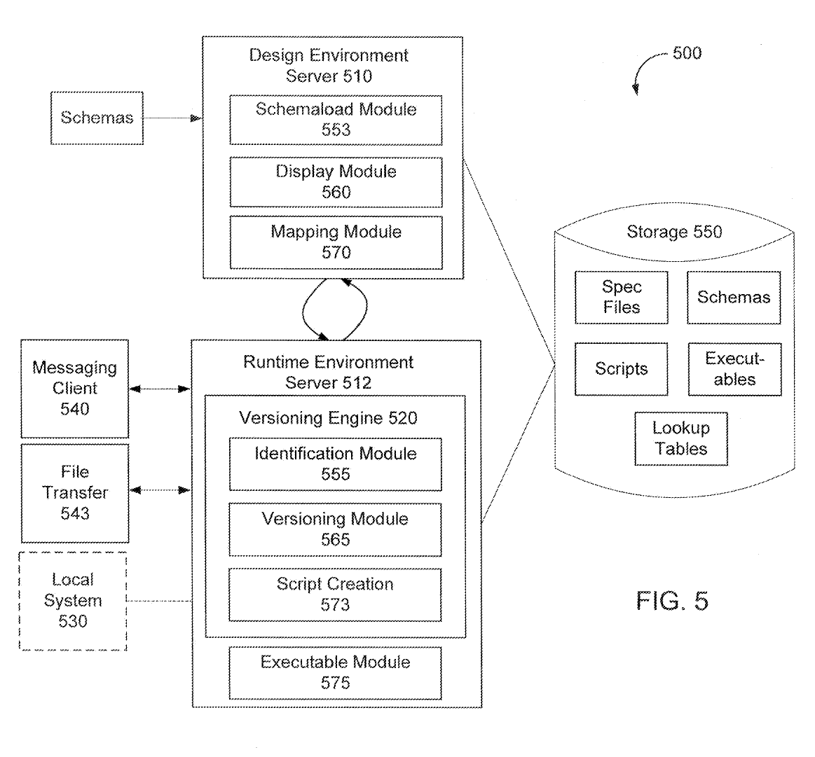

FIG. 5 is a block diagram illustrating the architecture of one embodiment of a system 500 useful for supporting a versioning engine 520 configured to create a customized executable for translating a message from one XML schema version into another XML schema version. In such a system 500, there is provided one or more servers 510, 512 which may be stand-alone devices or may be communicatively coupled to a network and/or one or more local systems 530, as indicated by dotted lines. In addition, the servers 510, 512 are adapted for communicating with one or more messaging clients 540, or file transfer repositories 543, e.g., for sending and receiving messages.

In one implementation, the system 500 operates on high performance server class computers 510, 512. The details of the hardware aspects of servers 510, 512 are well known to those of skill in the art and are not further described herein. The servers 510, 512 are depicted in FIG. 5 as two (logically or physically) separate servers: a design environment server 510 (for pre-run mapping functions) and a runtime environment server 512 (for run-time functions), however the system alternatively may be implemented as a single server, or as a network of computer processors and associated storage devices. Examples of server devices 510, 512 are servers, mainframe computers, networked computers, a processor-based device, and similar types of systems and devices. The servers 510, 512 and associated storage devices 550 need not be physically co-located, and there need not be any predefined mapping between storage devices 550 and server computers. The server processor can be any of a number of well known computer processors, such as processors from Intel Corporation of Santa Clara, Calif. and Motorola Corporation of Schaumburg, Ill. In one embodiment, the servers 510, 512 have sufficient processing power and bandwidth to perform the versioning functions described herein.

The local system 530, if present, is of conventional design, and includes a processor, an addressable memory, and other conventional features (not illustrated) such as a display, local memory, input/output ports, and a network interface. The network interface and a network communication protocol provide access to a network and other computers, such as servers 510, 512 if separate, and messaging clients 540 and/or file transfer 543, along with access to the Internet, via a TCP/IP type connection, or to other network embodiments, such as a LAN, a WAN, a MAN, a wired or wireless network, a private network, a virtual private network, via other networks, or other systems allowing for data communication between two or more computing systems. In various embodiments the local system 530 may be implemented on a computer running a Microsoft operating system, Mac OS, various flavors of Linux, UNIX, Palm OS, and/or other operating systems.

Messaging clients 540 also may be computer systems similar to that described above, and may range from a simple system to a complicated multi-computer system. In addition, messaging client 540 may be a third party, e.g., in a business-to-business setting, or may be included with the servers 510, 512 within the confines of a business or other organization or network of computers. Alternatively, messages may be provided to the server by way of a file transfer repository 543 or directory.

The design environment server 510 may include various software modules 553, 560, and 570. The software modules 553, 560, and 570 are comprised of a number of executable code portions and data files. These include code for executing the method and processes associated with creating a customizable mapping as described herein. Alternatively, the software modules 553, 560, and 570 can be implemented as a stand-alone application outside of, and in communication with, the design environment server 510.

The software modules 553, 560, and 570 are responsible for orchestrating the processes associated with pre-runtime functions, such as designing and using the customizable specification described herein. The software modules include a schemaload module 553, a display module 560, and a mapping module 570 according to one embodiment of the present invention.

The schemaload module 553 enables manipulation and assembly of schemas into displayable form, and is one means for so doing.

The display module 560 enables the user interface of the system 500 as described in conjunction with FIGS. 2A-2E, and allows the system to display customizable mapping specifications and mapping results, e.g., as discussed in conjunction with steps 120,150, and 160 of FIG. 1, and is one means for so doing.

The mapping module 570 enables the system 500 to process the specified mappings from the specification, e.g., as described in conjunction with steps 130 and 140 of FIG. 1, and is one means for so doing.

The runtime environment server 512 in may include a versioning engine 520 and an executable module 575. The versioning engine 520 and an executable module 575 are comprised of a number of executable code portions and data files. These include code for executing the method and processes associated with running the mapping and creating a customized executable as described herein. Alternatively, the versioning engine 520 and an executable module 575 can be implemented as stand-alone applications outside of, and in communication with, the runtime environment server 512.

The executable module 575 enables the system 500 to produce an executable as a result of the mapping, useful for transforming messages from one XML schema version to another as described in conjunction with step 170 of FIG. 1, and is one means for so doing. The executable module 575 reads the mapping file and creates an XML script. This script will then be processed by the runtime server 512, which reads the script and performs the steps designated therein.

The versioning engine 520 is responsible for orchestrating the runtime processes performed according to the methods of the present invention. The versioning engine 520 includes an identification module 555, a versioning module 565, and a script creation module 573.

The identification module 555 enables the system 500 to receive identification of source and target schema version information and specific output file format information, as described in conjunction with step 110 of FIG. 1, and is one means for so doing.

The versioning module 565 enables the system 500 to receive custom instructions via the specification described herein, for example designating automatic and manual mappings, and for running the versioning algorithms, e.g., as described in conjunction with steps 130 and 140 of FIG. 1, and is one means for so doing.

The script creation module 573 enables the system 500 to generate scripts as the computer-readable versions of the mappings as described in conjunction with FIGS. 3 and 4, and is one means for so doing.

The above modules 553-575 need not be discrete software modules. The software configuration shown is meant only by way of example; other configurations are contemplated by and within the scope of the present invention.

The servers 510, 512 may be accessed over a network by the user, using for example a browser interface to the versioning engine 520.

The data storage 550 may be a set of files on disk, a database, or any other form of storage that stores the data used by the modules 553-575. For example, the data storage may store schemas for use by the system 500, files designating mapping specifications and their corresponding computer-readable scripts, and executables for use in message processing according to the schemas and versioning described herein. The data storage 550 may be accessible by the modules 553-575 through a user interface, e.g., as described in conjunction with FIGS. 2A-2E. The modules 553-575 and the data storage 550 may be stored and operated on a single computer or on separate computer systems communicating with each other through a network.

One skilled in the art will recognize that the system architecture illustrated in FIG. 5 is merely exemplary, and that the invention may be practiced and implemented using many other architectures and environments.

### EXAMPLES

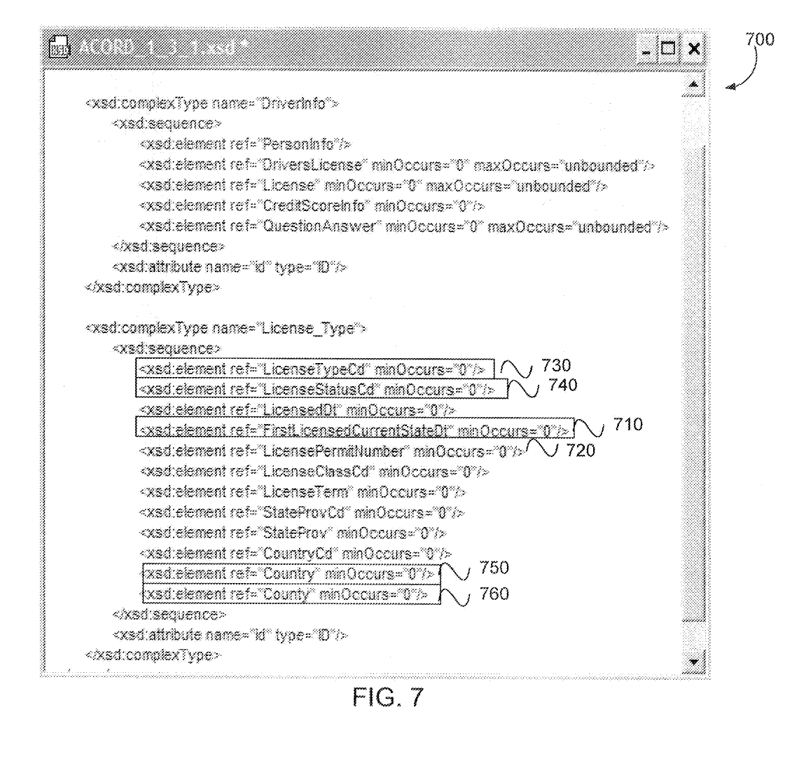

The following provides examples of version to version schema transformation between ACORD v. 1.2.0 and ACORD v. 1.3.1, standards set by the Association for Cooperative Operations Research and Development (ACORD) for the insurance industry. FIG. 6 shows a portion of an XML schema description (XSD) 600 for ACORD v. 1.2.0. FIG. 7 shows a portion of an XSD 700 for ACORD v. 1.3.1.

In the first example, a business using ACORD v. 1.3.1 receives a request, using ACORD v. 1.2.0 that the user wishes to upgrade to ACORD v. 1.3.1. Prior to the request message being received, the user can run a mapping from source schema version ACORD v. 1.2.0 to target schema version ACORD v. 1.3.1, using the process described above. Because in this example the standard itself has changed, a spreadsheet of changes may be available, e.g., from ACORD for manual input.

For example, the FirstLicensedCurrentStateDt element 610 of the ACORD v. 1.2.0 XSD 600 is in a different place relative to the License Number 620 (after the License Number) than it is in the ACORD v. 1.3.1 XSD 700 (FirstLicensedCurrentStateDt element 710), in which is it before the License Number 720. Thus, the mapping from ACORD v. 1.2.0 to ACORD v. 1.3.1 requires moving this element. In another example, the element PreviousLicensedStateProvCd 630 of the ACORD v. 1.2.0 XSD 600 does not exist in the ACORD v. 1.3.1 XSD 700. Thus, the mapping from ACORD v. 1.2.0 to ACORD v. 1.3.1 requires removing this element.

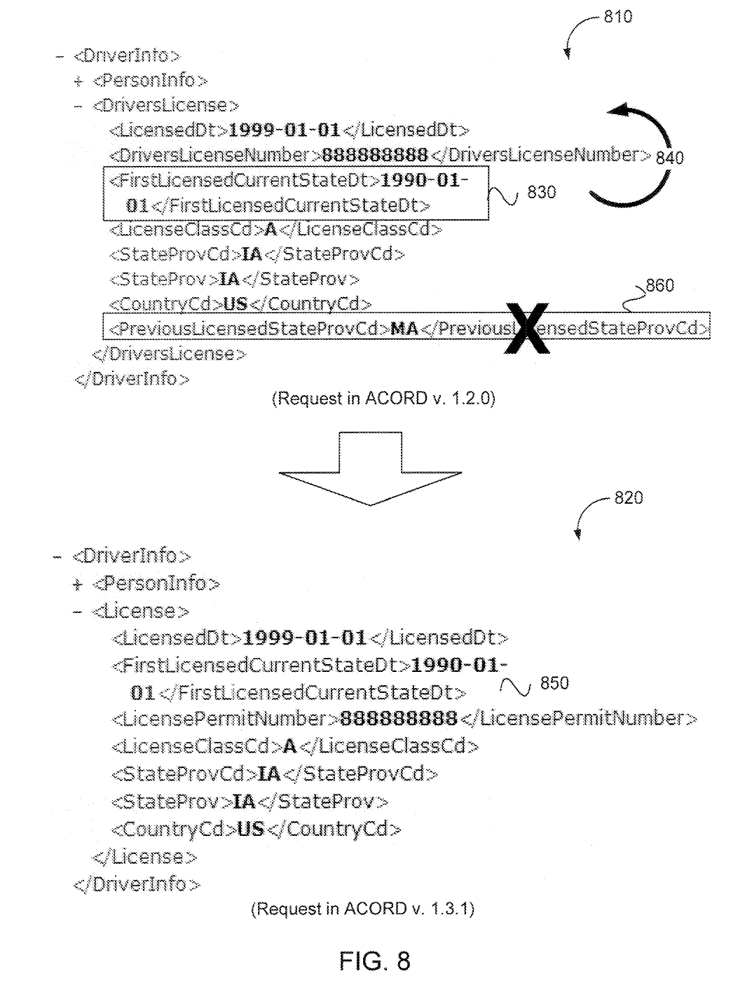

Referring now to FIG. 8, it shows a request pertaining to the portion of the XSD in ACORD v. 1.2.0 (810) and in ACORD v. 1.3.1 (820). Using the elements discussed above, the FirstLicensedCurrentStateDt element and value 830 in ACORD v. 1.2.0 (810) has been moved up 840 as a result of the mapping between these schema versions, as shown for the same element 850 in ACORD v. 1.3.1 (820). Likewise, the PreviousLicensedStateProvCd element and value 860 has been eliminated in ACORD v. 1.3.1 (820) as a result of the mapping between these schema versions, as indicated by the X over this element. The information is now in agreement with the user's standard usage of ACORD v. 1.3.1.

In the second example, a business using ACORD v. 1.3.1 wants to send a response out, downgraded to ACORD v. 1.2.0. Prior to the response message being sent, the user can run a mapping from source schema version ACORD v. 1.3.1 to target schema version ACORD v. 1.2.0, using the process described herein. Referring again to FIGS. 6 and 7, several elements present in the ACORD v. 1.3.1 XSD 700 are absent in the ACORD v. 1.2.0 XSD 600, including LicenseTypeCd 730, LicenseStatusCd 740, Country 750, and County 760. Thus, the mapping from ACORD v. 1.3.1 to ACORD v. 1.2.0 requires removing these elements. And as discussed with respect to the first example, the element FirstLicensedCurrentStateDt 710 is in a different location in ACORD v. 1.3.1 than in ACORD v. 1.2.0 (610). Thus, the mapping from ACORD v. 1.3.1 to ACORD v. 1.2.0 requires moving this element.

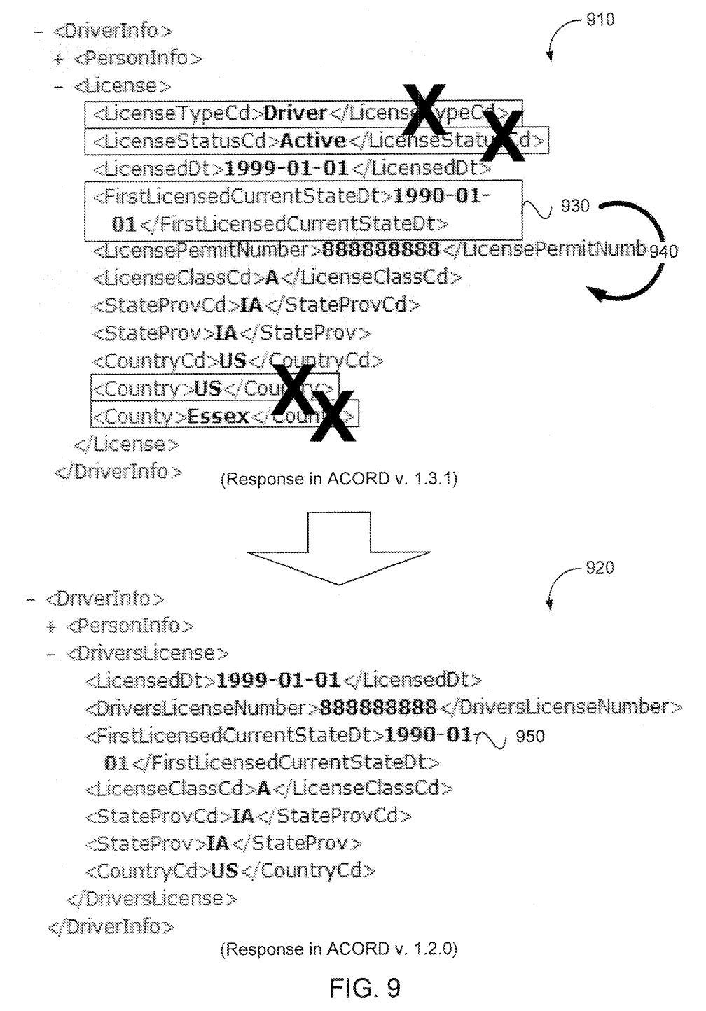

Referring now to FIG. 9, it shows a response pertaining to the portion of the XSD in ACORD v. 1.3.1 (910) and in ACORD v. 1.2.0 (920). Using the elements discussed above, the FirstLicensedCurrentStateDt element and value 930 in ACORD v. 1.3.1 (910) has been moved down 940 as a result of the mapping between these schema versions, as shown for the same element 950 in ACORD v. 1.2.0 (920). Likewise, the LicenseTypeCd 730, LicenseStatusCd 740, Country 750, and County 760 elements and values have been eliminated in ACORD v. 1.2.0 (920) as a result of the mapping between these schema versions, as indicated by the X over these elements. The information is now in agreement with the response recipient's standard usage of ACORD v. 1.2.0.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method of creating a customized executable for translating a message received in a source extensible markup language (XML) schema version to a target XML schema version, comprising:
receiving identification of a source XML schema version and a target XML schema version;
loading a customizable mapping specification for mapping elements of the source XML schema version to the target XML schema version;
displaying the customizable mapping specification;
receiving via the customizable mapping specification a set of instructions for the mapping, the instructions designating elements of the mapping for automatic and for manual mapping;
processing the mapping according to the customizable mapping specification and set of instructions, the mapping comprising application of a set of mapping routines;
displaying mapping execution results for the executed mapping; and
rendering from the mapping specification an executable configured to translate a message from the source XML schema version to a message in the target XML schema version.

2. The method of claim 1, wherein the source XML schema version and the target XML schema version are selected from a list of stored schema versions.

3. The method of claim 1, wherein the customizable specification is in the form of a spreadsheet.

4. The method of claim 1, wherein:
the set of instructions for the mapping comprises an instruction not to map a selected element; and
the processing omits application of a selected routine from the set of mapping routines corresponding to the selected element.

5. The method of claim 1, wherein:
the set of instructions for the mapping comprises a manual mapping for a selected element; and
the processing substitutes the manual mapping of the selected element for a selected routine from the set of mapping routines corresponding to the selected element.

6. The method of claim 1, wherein the set of mapping routines comprise mapping routines provided by a standards-setting organization.

7. The method of claim 1, wherein the set of mapping routines comprise default routines for the mapping.

8. The method of claim 7, wherein the default routines for the mapping are selected from the group consisting of similarity, schema structure, thesauri, instances, value distribution of instances, constraints, past mappings, similarity to standard schemas, and cluster analysis of a schema corpus.

9. The method of claim 1, wherein the set of mapping routines comprise manually configured routines for the mapping.

10. The method of claim 1, wherein the mapping execution results comprise an indication that specified elements were not mapped.

11. The method of claim 10, wherein the indication is an error message.

12. The method of claim 10, wherein the indication is a report.

13. The method of claim 10, further comprising:
receiving via the customizable specification additional instructions for the mapping corresponding to the specified elements;
processing the mapping according to the additional instructions to produce an updated mapping; and
wherein the rendered executable comprises the updated mapping.

14. The method of claim 10, wherein the indication does not cause failure of the entire mapping.

15. The method of claim 1, further comprising:
receiving information regarding a desired data messaging format for the executable; and
formatting the executable into the desired data messaging format.

16. A computing system for creating a customized executable for translating a message received in a source extensible markup language (XML) schema version to a target XML schema version, the system comprising:
means for receiving identification of a source XML schema version and a target XML schema version;
means for loading a customizable mapping specification for mapping elements of the source XML schema version to the target XML schema version;
means for displaying the customizable mapping specification;
means for receiving via the customizable mapping specification a set of instructions for the mapping, the instructions designating elements of the mapping for automatic and for manual mapping;
means for processing the mapping according to the customizable mapping specification and set of instructions, the mapping comprising application of a set of mapping routines;
means for displaying mapping execution results for the executed mapping; and
means for rendering from the mapping specification an executable configured to translate a message from the source XML schema version to a message in the target XML schema version.

17. The system of claim 16, wherein the customizable specification is in the form of a spreadsheet.

18. The system of claim 16, wherein:
the set of instructions for the mapping comprises an instruction not to map a selected element; and
the processing omits application of a selected routine from the set of mapping routines corresponding to the selected element.

19. The system of claim 16, wherein:
the set of instructions for the mapping comprises a manual mapping for a selected element; and
the processing substitutes the manual mapping of the selected element for a selected routine from the set of mapping routines corresponding to the selected element.

20. The system of claim 16, wherein the mapping execution results comprise an indication that specified elements were not mapped.

21. The system of claim 20, further comprising:
means for receiving via the customizable specification additional instructions for the mapping corresponding to the specified elements;
means for processing the mapping according to the additional instructions to produce an updated mapping; and
wherein the rendered executable comprises the updated mapping.

22. The system of claim 16, further comprising:
means for receiving information regarding a desired data messaging format for the executable; and
means for formatting the executable into the desired data messaging format.

23. A computer program product for creating a customized executable for translating a message received in a source extensible markup language (XML) schema version to a target XML schema version, the computer program product comprising:
a computer-readable medium; and
computer program code, coded on the medium, for:
receiving identification of a source XML schema version and a target XML schema version;
loading a customizable mapping specification for mapping elements of the source XML schema version to the target XML schema version;
displaying the customizable mapping specification;
receiving via the customizable mapping specification a set of instructions for the mapping, the instructions designating elements of the mapping for automatic and for manual mapping;
processing the mapping according to the customizable mapping specification and set of instructions, the mapping comprising application of a set of mapping routines;
displaying mapping execution results for the executed mapping; and
rendering from the mapping specification an executable configured to translate a message from the source XML schema version to a message in the target XML schema version.

24. The computer program product of claim 23, wherein the customizable specification is in the form of a spreadsheet.

25. The computer program product of claim 23, wherein:
the set of instructions for the mapping comprises an instruction not to map a selected element; and
the processing omits application of a selected routine from the set of mapping routines corresponding to the selected element.

26. The computer program product of claim 23, wherein:
the set of instructions for the mapping comprises a manual mapping for a selected element; and
the processing substitutes the manual mapping of the selected element for a selected routine from the set of mapping routines corresponding to the selected element.

27. The computer program product of claim 23, wherein the mapping execution results comprise an indication that specified elements were not mapped.

28. The computer program product of claim 27, further comprising computer program code for:
receiving via the customizable specification additional instructions for the mapping corresponding to the specified elements;
processing the mapping according to the additional instructions to produce an updated mapping; and
wherein the rendered executable comprises the updated mapping.

29. The computer program product of claim 23, further comprising:
receiving information regarding a desired data messaging format for the executable; and
formatting the executable into the desired data messaging format.
